(19) United States
(12) Patent Application Publication
(10) Pub. No.: US 2025/0224740 A1
(43) Pub. Date: Jul. 10, 2025

(54) GROUND ROBOT MOBILITY CONTROL METHOD SWITCHING

(71) Applicant: Textron Systems Corporation, Hunt Valley, MD (US)

(72) Inventors: Lowry Michael Davidson, JR., Reisterstown, MD (US); Aaron Russell Grieb, Spring Grove, PA (US)

(21) Appl. No.: 19/009,220

(22) Filed: Jan. 3, 2025

Related U.S. Application Data
(60) Provisional application No. 63/617,478, filed on Jan. 4, 2024.

(51) Int. Cl. G05D 1/65; B60K 1/02; B60L 7/10; B60L 15/20; B62D 55/06; G05D 1/225; G05D 1/229; G05D 109/10

(52) U.S. Cl. CPC G05D 1/65; B60K 1/02; B60L 15/20; G05D 1/225; G05D 1/229; B60L 7/10; B60L 2240/12; B60L 2240/14; B60L 2240/22; B60L 2240/421; B60L 2240/423; B62D 55/06; G05D 2109/10

(57) ABSTRACT

A technique for controlling a tracked robotic vehicle includes simultaneously operating multiple control methods within the vehicle based on established settings but selecting only a single control method for controlling the vehicle at a time. With the vehicle using a first control method, the vehicle receives a command for assuming a second control method and responds by selecting the second control method in place of the first control method for controlling the vehicle. Because the second control method is already operational with established settings when the command is received, the vehicle can transition instantly from the first control method to the second control method without having to stop the vehicle.

### CROSS-REFERENCE TO RELATED APPLICATIONS

This application claims the benefit of U.S. Provisional Patent Application No. 63/617,478, filed Jan. 4, 2024, the contents and teachings of which are incorporated herein by reference in their entirety.

### BACKGROUND

Tracked robotic vehicles, also referred to as “ground robots,” typically operate under remote control. For example, a remote user may operate a computer, which wirelessly sends commands to the ground robot for advancing, turning, stopping, and the like. The ground robot typically includes a transceiver for receiving the commands from the computer and for transmitting live video or other images captured by cameras of the robot back to the computer for viewing by the user.

Some ground robots support multiple driving methods, such as torque control and speed control. With torque control, the user establishes desired torque settings for motors driving left and right tracks of the robot, and the robot responds by running the motors at the desired torque levels. The user may increase or decrease the torque of each motor independently, e.g., using one or more joysticks or other input devices connected to the computer. With speed control, the user sets a desired speed of the robot, and the robot responds by running the motors in a manner that achieves the desired speed. The robot may respond to steering input from the computer for steering the robot while maintaining the desired speed.

### SUMMARY

The above-described ground robots offer limited options for drive control methods and typically do not switch easily between different drive control methods. Switching drive control methods can be useful when terrain changes (e.g., when encountering hills), when adding cargo to the robots, or when towing items behind the robots. Unfortunately, switching drive control methods in existing ground robots is typically complex and involves stopping the robot, sending new settings to the robot for use with a new drive control method, sending instructions to the robot for switching to the new drive control method, and restarting the robot with the new drive control method in place. Such switching thus entails delays, as well as a careful orchestration of commands by the remote user, who is susceptible to human error. What is needed, therefore, is a more automated solution for switching drive control methods that avoids having to stop the vehicle and is simpler for the user to perform.

The above need is addressed at least in part by an improved technique for controlling a tracked robotic vehicle. The technique includes simultaneously operating multiple control methods within the vehicle based on established settings but selecting only a single control method for controlling the vehicle at a time. With the vehicle using a first control method, the vehicle receives a command for assuming a second control method and responds by selecting the second control method in place of the first control method for controlling the vehicle. Because the second control method is already operational with established settings when the command is received, the vehicle can transition instantly from the first control method to the second control method without having to stop the vehicle.

Certain embodiments are directed to a method of operating a vehicle. The method includes controlling the vehicle using a first drive-control method in response to receiving a first set of messages from a control computer separate from the vehicle. While controlling the vehicle using the first drive-control method, the method further includes operating a second drive-control method that does not control the vehicle and, in response to receiving a second set of messages from the control computer, switching from the first drive-control method to the second drive-control method such that the vehicle is controlled using the second drive-control method but not the first drive-control method.

Other embodiments are directed to a tracked vehicle. The tracked vehicle includes first and second tracks, first and second motors respectively coupled to the first and second tracks, a traction motor inverter coupled to the first and second motors, and control circuitry constructed and arranged to: control the vehicle using a first drive-control method in response to receipt of a first set of messages from a control computer separate from the vehicle; while the vehicle is controlled using the first drive-control method, operate a second drive-control method that does not control the vehicle; and in response to receipt of a second set of messages from the control computer, switch from the first drive-control method to the second drive-control method such that the vehicle is controlled using the second drive-control method but not the first drive-control method.

The foregoing summary is presented for illustrative purposes to assist the reader in readily grasping example features presented herein; however, this summary is not intended to set forth required elements or to limit embodiments hereof in any way. One should appreciate that the above-described features can be combined in any manner that makes technological sense, and that all such combinations are intended to be disclosed herein, regardless of whether such combinations are identified explicitly or not.

### BRIEF DESCRIPTION OF THE SEVERAL VIEWS OF THE DRAWINGS

The foregoing and other features and advantages will be apparent from the following description of particular embodiments, as illustrated in the accompanying drawings, in which like reference characters refer to the same or similar parts throughout the different views. The drawings are not necessarily to scale, emphasis instead being placed upon illustrating the principles of various embodiments.

FIG. 1 is a block diagram of an example environment in which embodiments of the improved technique can be practiced.

FIG. 2 is a block diagram of an example control computer shown in FIG. 1.

FIG. 3 is a block diagram of an example electronic system in an example tracked robotic vehicle shown in FIG. 1.

FIG. 4 is an example screenshot displayed by a GUI of the control computer in response to a torque control method or an aided torque control method being selected.

FIG. 5 is an example screenshot displayed by the GUI of the control computer in response to a speed control method being selected.

FIG. 6 is an example screenshot displayed by the GUI of the control computer in response to a heading control method being selected.

FIG. 7 is an example screenshot displayed by the GUI of the control computer in response to a waypoints control method being selected.

FIG. 8 is an example screenshot displayed by the GUI of the control computer in response to a configuration control being activated.

FIG. 9 is a flowchart showing an example method of controlling the tracked robotic vehicle of FIG. 1 using a control computer.

### DETAILED DESCRIPTION

Embodiments of the improved technique will now be described. One should appreciate that such embodiments are provided by way of example to illustrate certain features and principles but are not intended to be limiting.

An improved technique for controlling a tracked robotic vehicle includes simultaneously operating multiple control methods within the vehicle based on established settings but selecting only a single control method for controlling the vehicle at a time. With the vehicle using a first control method, the vehicle receives a command for assuming a second control method and responds by selecting the second control method in place of the first control method for controlling the vehicle. Because the second control method is already operational with established settings when the command is received, the vehicle can transition instantly from the first control method to the second control method without having to stop the vehicle.

In some examples, the vehicle includes a computerized system having a wireless interface constructed and arranged to receive wireless messages from control computer located an arbitrary distance away from the vehicle. The messages include control-method-selection commands for selecting one user-specified control method at a time.

In some examples, the computerized system includes multiple drive-control paths provided for respective control methods. The drive-control paths all feed into a motor controller application constructed and arranged to drive a set of motors of the vehicle. The motor controller application is constructed and arranged to respond to a command for assuming a new control method by selecting the drive-control path that provides the new control method and controlling the set of motors using the selected drive-control path but no other drive-control path.

In some examples, multiple control methods have respective control settings, and the technique includes simultaneously operating the respective control paths using the respective control settings.

In some examples, the control methods include a torque control method in which torques produced by motors driving left and right tracks of the vehicle are individually controllable. The user of the control computer may adjust the torque for each track independently using one or more joysticks or other controls.

In some examples, the control methods include an aided torque control method. This method is similar to the torque control method but applies smoothing and/or scaling that make it easier for a human to control. Such smoothing and/or scaling may be performed by the vehicle and/or by the control computer.

In some examples, the control methods include a speed method in which an established vehicle speed is maintained. For example, a maximum speed setting may be entered by the user via a graphical user interface (GUI) of the control computer, and the setting may be sent to the vehicle responsive to the user operating a control, such as a button. Steering may be achieved by the user via a joystick or other input device. In some examples, users may further establish a yaw rate to specify turning using absolute units, such as degrees per unit time, and the vehicle maintains the specified yaw rate as well as the specified speed. In some examples, speed may be trimmed up and down using a separate control pad.

In some examples, the control methods include a heading method in which the vehicle executes turning maneuvers based on predetermined settings. The settings may include, for example, a specified angle by which the vehicle is to turn and a turning method, such as right-track-only, left-track-only, or both tracks. A button or other control may be provided on the GUI of the control computer for initiating the maneuver. The same button or control, or a different one, may be provided for stopping the maneuver.

In some examples, the control methods include a waypoints method in which the vehicle receives a sequence of geographical coordinates and proceeds to drive automatically to each coordinate in the order specified by the sequence.

In some examples, the control methods include any combination of a torque control method, and aided torque control method, a speed method, a heading method, and a waypoints method.

In some examples, while the vehicle is operating using the waypoints method, the control computer automatically interprets joystick or other predetermined control input as a command to switch to the speed method and sends a command to the vehicle to start using the speed method, upon which the vehicle responds to the command by employing the speed method.

In some examples, while the vehicle is operating using the heading method, the control computer automatically interprets joystick or other predetermined control input as a command to switch to the speed method and sends a command to the vehicle to start using the speed method, upon which the vehicle responds to the command by employing the speed method.

In some examples, the vehicle is programmed with settings for multiple control methods such that the settings for a new control method are already in place when the vehicle receives a command to operate using the new control method, thereby enabling the vehicle to begin operating immediately using the new control method in accordance with the settings for the new control method.

In some examples, the vehicle includes sensors, such as one or more motor speed sensors, one or more motor torque sensors, an inertial measurement unit (IMU), which may include a pitch sensor for measuring vehicle pitch, an INS (inertial navigation solution) system for measuring vehicle location, a GPS (global positioning sensor) receiver, and the like, which the vehicle may use for navigation and as feedback signals for the various control methods.

In some examples, the control computer is programmable with general settings that define limits on maximum speed and/or maximum yaw rate that the control computer is allowed to command of the vehicle when using any of the control methods.

In some examples, the GUI includes different controls for respective control methods, such that controls displayed by the GUI change as the user changes control methods.

In some examples, the GUI includes fields for specifying user-defined mobility limits allowed for the vehicle. The GUI includes a control for sending the specified mobility limits to the vehicle. In such cases, the vehicle is constructed and arranged to respond to received mobility limits by enforcing those limits during its operation.

In some examples, the mobility limits include settings for any of maximum speed, maximum acceleration, maximum yaw rate, maximum differential braking rate, maximum torque, maximum deceleration, whether the vehicle is allowed to use regenerative braking, and whether the vehicle is allowed to perform zero turning. Any of these settings may be provided in any combination.

In some examples, the vehicle produces telemetry data and transmits the telemetry data to the control computer, which displays the telemetry data via the GUI. The telemetry data provides real-time, or near real-time data regarding the condition and operation of the vehicle.

In some examples, the vehicle includes a set of cameras, such as a front-facing camera, a rear-facing camera, a left-facing camera, and a right-facing camera. Some embodiments may include fewer cameras, such as only a front camera or only a front-facing camera and a rear-facing camera. Other embodiments may include additional cameras.

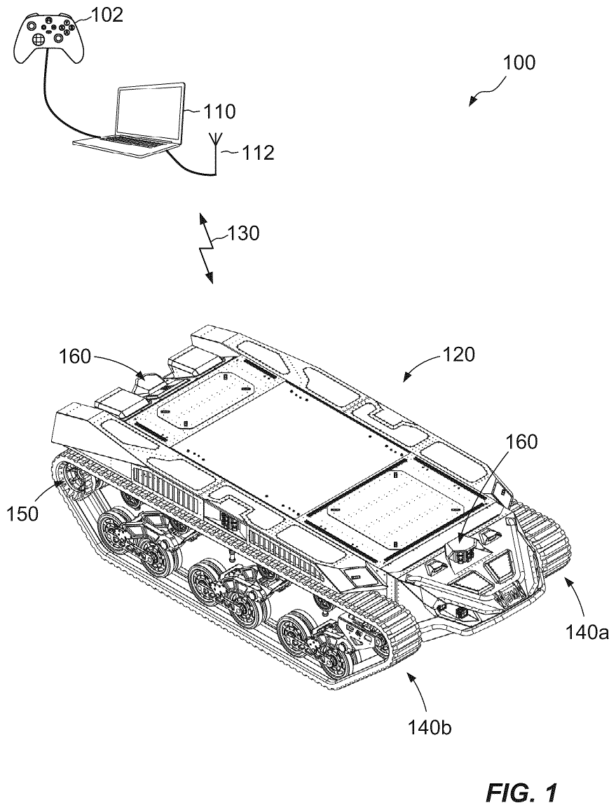

FIG. 1 shows an example environment 100 in which embodiments of the improved technique can be practiced. Here, a handheld controller 102 is operatively connected to a control computer 110 for controlling a robotic tracked vehicle 120. A connection between the controller 102 and the computer 110 may be made using a cable (as shown) or wirelessly, such as using Bluetooth or some other wireless protocol. The hand-held controller 102 may be a standard, commercially available game controller (e.g., an Xbox Controller) or it may be a custom controller, the particulars of which are not critical. In some embodiments, the controller 102 may be replaced with a conventional keyboard, mouse, or other input device. The control computer 110 may be any type of computer capable of running software, providing a GUI to support interaction with the user, and capable of connecting to an antenna 112 for supporting wireless communication, such as Wi-Fi, Bluetooth, Satellite, or the like. Examples of the control computer 110 include a laptop computer, desktop computer, tablet computer, game controller, or the like. The antenna 112 may be separate from the computer 110 (as shown), or it may be built into the computer.

A human user (not shown), or some other user, such as a robot, program, machine, or the like, may operate the controller 102 for controlling the robotic tracked vehicle 120 using wireless signals 130. The robotic tracked vehicle may be located an arbitrary distance away from the control computer 110. The vehicle 120 is constructed and arranged to receive commands and other messages from the control computer 110 and to respond to those commands and other messages by assuming various drive-control methods and by driving in accordance with those drive-control methods.

In an example, the vehicle 120 includes left and right tracks 140a and 140b, which may be driven forward and back by respective motors (not shown) via respective drive sprockets 150. Each drive sprocket 150 has teeth that engage a respective track (left or right). The vehicle 120 further includes various cameras 160 for capturing live video of the vehicle's surroundings. The vehicle 120 may transmit the live video back to the control computer 110, or to some other computer co-located with the control computer 110, for presenting the live video to the user, who may employ the live video for guiding the vehicle through the surrounding terrain using the controller 102 and the GUI displayed by the control computer 110.

In accordance with one or more embodiments, the vehicle 120 is constructed and arranged to switch seamlessly and rapidly among multiple control methods, such as torque, aided torque, speed, heading, and waypoint control methods. This ability enables the vehicle 120 to adapt quickly to different circumstances and terrains without having to stop the vehicle 120 and without the user having to orchestrate complex procedures.

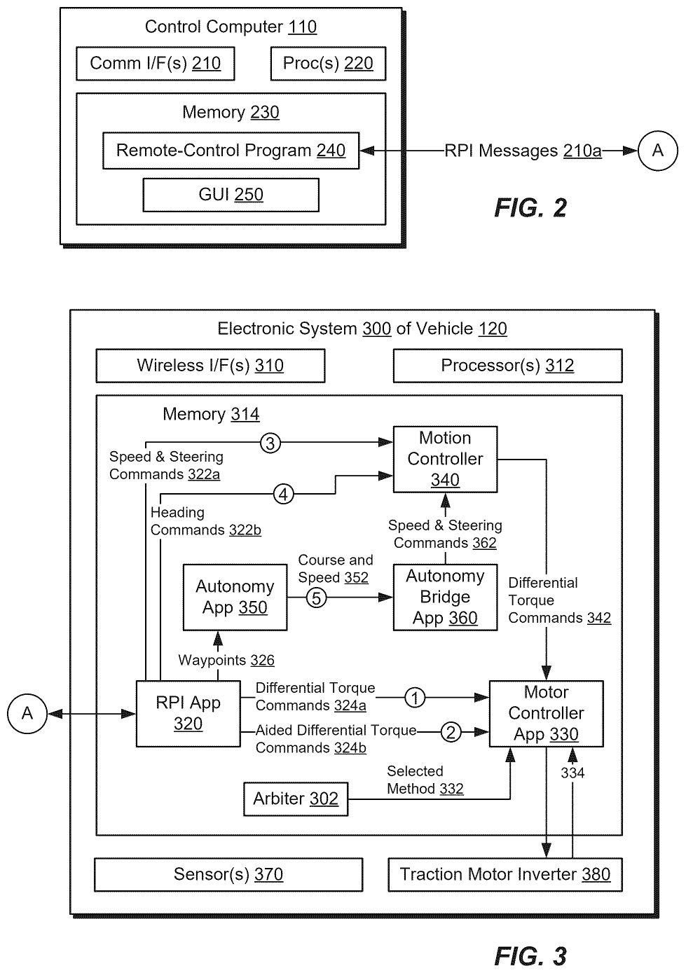

FIG. 2 shows an example control computer 110 in additional detail. As shown, the control computer 110 includes one or more communication interfaces 210, a set of processors 220, and memory 230. The communication interface(s) 210 include, for example, a wireless communication interface for sending and receiving messages via the antenna 112 (FIG. 1). The processor(s) 220 include one or more processing chips and/or assemblies, such as any number of multi-core CPUs (central processing units). The memory 230 includes both volatile memory, e.g., RAM (Random Access Memory), and non-volatile memory, such as one or more ROMs (Read-Only Memories), disk drives, solid state drives, and the like. The processor(s) 220 and the memory 230 together form control circuitry, which is constructed and arranged to carry out various methods and functions as described herein. Also, the memory 230 includes a variety of software constructs realized in the form of executable instructions. When the executable instructions are run by the processor(s) 220, the processor(s) 220 are made to carry out the operations of the software constructs. Although certain software constructs are specifically shown and described, it is understood that the memory 230 typically includes many other software components, which are not shown, such as an operating system, various applications, processes, and daemons.

As further shown in FIG. 2, the memory 230 “includes,” i.e., realizes by execution of software instructions, a remote-control program 240 and a GUI 250. The remote-control program 240 is a software construct constructed and arranged to receive user input from the GUI 250 and to respond to the user input by sending robotic platform interface (RPI) messages 210a to the vehicle 120. Such RPI messages 210a can prescribe a wide range of vehicle functions, which include drive-control method commands and other messages for establishing desired drive control methods and their associated settings. RPI messages 210a may also be received from the vehicle 120, for providing telemetry data produced by the vehicle 120. Such telemetry data may be displayed by the control computer 110 via the GUI 250. In some examples, the GUI 250 is integral with the remote-control program 240 rather than being a distinct software component.

FIG. 3 shows portions of an example electronic system 300 of the vehicle 120. The electronic system 300 includes one or more communication interfaces 310, a set of processors 312, and memory 314, which may be provided in similar forms and with similar capabilities as the corresponding features 210, 220, and 230 described in connection with FIG. 2. The electronic system 300 may further include various sensors 370, such as an IMU, a GPS receiver, an INS system, a speedometer, and the like, as well as a traction motor inverter 380. The traction motor inverter 380 is constructed and arranged to drive motors (not shown) of the vehicle 120, such as left and right motors for driving the left and right tracks 140a and 140b of the vehicle (FIG. 1). In some examples, the traction motor inverter 380 is constructed and arranged to generate one or more feedback signals, such as torque levels produced by the motors, which may be based on current drawn by the motors during operation (assuming electric motors are used). Although not shown, each motor may be coupled to a respective drive sprocket 150 of the vehicle 120 via a respective drive shaft and gearbox.

As further shown in FIG. 3, the memory 314 includes an arbiter 302, a robotic platform interface (RPI) application 320, a motor controller application 330, a motion controller 340, an autonomy application 350, and an autonomy bridge application 360. The arbiter 302 is constructed and arranged to indicate which of multiple drive control methods is currently active. The RPI application 320 is constructed and arranged to communicate with the control computer using RPI messages 210a. In an example, RPI messages 210a are sent and received in accordance with a messaging protocol that is optimized for remote control. Any protocol may be used, however. Examples of RPI messages 210a include commands for establishing drive control methods and associated settings, as well as commands for directly driving the vehicle 120.

The motor controller application 330 is constructed and arranged to receive inputs specifying desired torque levels and to provide output signals for driving the traction motor inverter 380 for powering the left and right motors in such a way as to generate the prescribed torque levels. A torque feedback signal 334 may be provided for each motor for supporting closed-loop control over motor torque. The motor controller application 330 is further constructed and arranged to receive a selected method 332, which may be produced by the arbiter 302. The selected method 332 identifies a currently selected drive control method, e.g., one of torque, aided torque, speed, heading, and waypoint control methods. The motor controller application 330 is further constructed and arranged to respond to the selected method 332 by enabling control using the selected method 332 and disabling control using the other methods. One should appreciate that the functions ascribed to the arbiter 302 may instead be performed by other constructs, such as the RPI application 320.

The software constructs shown within memory 314 support multiple drive-control paths, one for each drive-control method. The different drive-control paths are labeled with encircled numerals 1-5, where path (1) indicates torque control, path (2) indicates aided torque control, path (3) indicates speed control, path (4) indicates heading control, and path (5) indicates waypoint control.

For torque control, the drive-control path (1) is formed between the RPI application 320 and the motor controller application 330. Differential torque commands 324a may specify left and right torque values in relative terms, e.g., from −100% to +100%, where −100% represents the maximum reverse-driving torque available from each motor and +100% represents the maximum forward-driving torque. With the torque control method, for example, the motor controller application 330 drives the traction motor inverter 380 so as to achieve the left and right torque levels prescribed by the differential torque commands 324a.

Aided torque control is similar to torque control and follows a parallel (or identical) path (2), but in this case aided differential torque commands 324b (e.g., also expressed as percentages) provide smoothed or otherwise processed torque values, which are intended to make it easier for human operators to control the vehicle 120. For example, raw torque values may be based on joystick position of the handheld controller 102, which may be sensitive to small deflections. Aided torque may provide moving averages of torque values to prevent sudden, inadvertent changes. It may also remap controller input, such as by requiring greater stick deflections for incremental changes near 0% torque than are required for incremental changes near+/−100% torque, e.g., by remapping stick input to a logarithmic scale. The processing of raw stick input to processed torque values may be performed by any suitable component, such as within the RPI application 320, within the control computer 110, or elsewhere.

For speed control, the drive-control path (3) is formed from the RPI application 320, to the motion controller 340, and then to the motor controller application 330. The RPI application 330 translates RPI messages 210a from the control computer 110 to speed and steering commands 322a. The speed and steering commands 322a may include speed settings, yaw-rate settings, and direct steering input, e.g., from a control stick. In an example, the motion controller 340 operates under closed-loop control, receiving feedback from the sensors 370 and/or the traction motor inverter 380 and transforming the speed and steering commands 322a into differential (left and right) torque commands 342. These torque commands 342 are fed to the motor controller application 330, which drives the traction motor inverter 380 as described above to power the left and right motors. The feedback is closed when the speed of the left and right motors matches the speed prescribed by the speed and steering commands 322a.

The term “application” as used in describing certain features of FIG. 3 refers to a software component constructed and arranged to perform certain indicated functions, such as real-time control functions. An application may be realized as a stand-alone application, a plug-in or add-in, a subroutine or function, a software object, or any other software construct that includes instructions.

For heading control, the drive-control path (4) starts at the RPI application 320, proceeds to the motion controller 340, and then proceeds to the motor controller application 330. In an example, this path (4) is parallel to (or identical to) the speed-control path (3). Here, however, the RPI application 320 translates input from the control computer 110 to heading commands 322b, which the motion controller 340 transforms into differential torque commands 342. The heading commands 322b specify particular turning maneuvers, which may be performed while the vehicle 120 is stopped or when it is in motion. In an example, turning of the vehicle 120 is achieved by establishing differential track speeds. For example, the sensors 370, such as the IMU, monitor yaw of the vehicle and enable a turn may be completed under closed-loop control. Speed may also be maintained under closed-loop control based on feedback from sensors 370 and/or from the traction motor inverter 380.

For waypoints control, the drive-control path (5) starts with the RPI application 320 and proceeds to the autonomy application 350, then to the autonomy bridge application 360, then to the motion controller 340, and then to the motor controller application 330. In some examples, the autonomy application 350 and the autonomy bridge application 360 are provided as a single software construct. According to this control method, the RPI application 320 translates one or more RPI messages 210a from the control computer 110 into a set of waypoints 326, e.g., latitude and longitude coordinates, to be visited in a defined sequence. The autonomy application 350 transforms the sequence of waypoints 326 into a corresponding sequence of course (direction) and speed settings 352, which vary as the vehicle 120 progresses from one waypoint to another. In some examples, the autonomy application 350 may be a “smart” application that avoids obstacles, follows roads when available, and applies other features to promote safe travel. The autonomy bridge application 360 transforms the course and speed settings 352 to corresponding speed and steering commands 362, which the motion controller 340 transforms to differential torque commands 342 in the manner described above.

In an example, the above-described drive-control paths (1) through (5), or some subset of these paths, are kept in a continuously active state, such that they have the settings needed for their operation and are primed such that they can immediately take control of the vehicle once they are selected. For example, assume that the vehicle 120 is operating using the speed control method, as indicated by path (3). During this time, the drive-control path (5) for the waypoint control method remains active, continually generating course and speed 352 for traveling to the next waypoint. Likewise, the autonomy bridge application 360 may continuously produce speed and steering commands 362. When a new RPI message 210a arrives specifying a change to the waypoint control method, the electronic system 300 responds by changing the selected method 332 to waypoints, at which point the motor controller application 330 proceeds to control the vehicle 120 using drive-control path (5).

As another example, assume that the vehicle 120 is operating using the aided torque control method, as indicated by path (2). During this time, the vehicle continues to provide speed and steering commands 322a to the motion controller 340, which in turn continues to generate differential torque commands 342, even though the speed control method is not currently selected. When a new RPI message 210a arrives specifying a transition to the speed control method, the motor controller application 330 responds by switching control to path (3), controlling the vehicle using the now selected speed control method. In this manner, transitions between different drive control methods are fast and efficient.

One may observe that continuing to operate drive-control paths that are not currently selected may cause certain paths that normally operate closed-loop to operate open-loop instead. For example, when either of the torque control settings is selected, the motion controller 340 operates open loop, as it has no control over the motors. In such cases, the motion controller 340 may limit its output to values close to expected values when the motion controller 340 does control the motors, such that a transition from either torque method to the speed, heading, or waypoints method can be achieved smoothly and without sudden jumps. In an example, the arbiter 302 determines which drive-control path is currently selected and provides this information (e.g., indicator 332) to all of the drive-control paths, where they are made “aware” of whether they are currently selected. Drive-control paths that are not currently selected can then limit their output excursions in response to large errors. Although the switching of drive-control methods as described herein may be performed directly and without first stopping the vehicle 120, nothing precludes the user from stopping the vehicle 120 when changing drive-control methods. Stopping the vehicle 120 is thus at the user's discretion.

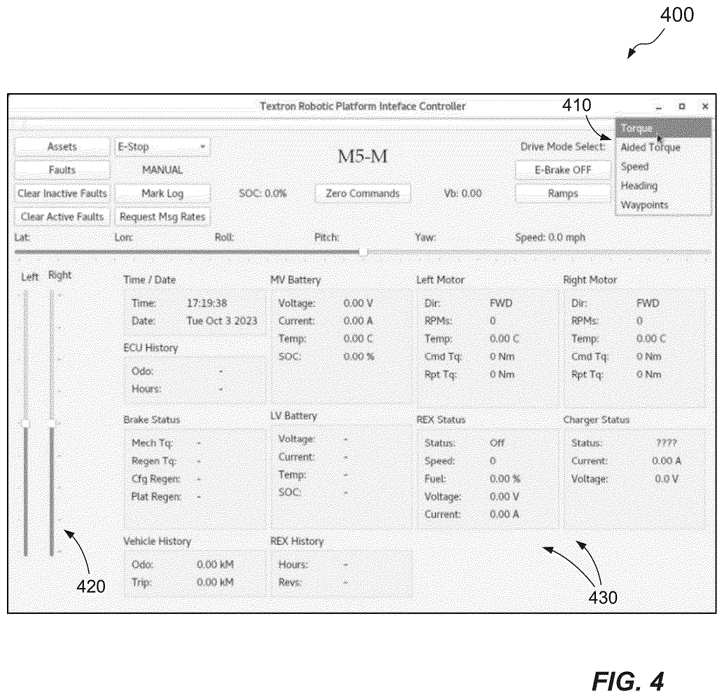

Having described the control operation of the vehicle 120, operation of the control computer 110 that facilitates such vehicle operation will now be described in connection with FIGS. 4 through 8. One should appreciate that the depicted screenshots of FIGS. 4 through 8 are intended merely for illustration and are not intended to be limiting. In an example, the screenshots are rendered by the GUI 250, which may be viewed on a display of the control computer 110, and which may be operated using the handheld controller 102 and/or other input devices, such as a keyboard and/or mouse. Logic behind the GUI 250 and activities prescribed by the GUI may be provided by the remote-control program 240.

FIG. 4 shows an example screenshot 400 of the GUI 250. Here, the user has selected the differential torque control method (“Torque”) from a drop-down list 410, which also allows for selection of the other drive control methods (aided torque, speed, heading, and waypoints). Selecting “Torque” from the drop-down list 410 causes the remote-control program 240 to send one or more RPI messages 210a to the vehicle 120, which receives the message(s) 210a and proceeds to switch to the drive-control path (1). Settings for left and right torque may have initial default values, which may reflect previous settings or may start from zero. A method-specific region 420 of the GUI 250 provides a visual representation of commanded torque to left and right motors. A status region 430 of the GUI provides status information, which may include vehicle telemetry, i.e., parameters monitored by the vehicle 120 and sent back to the control computer 110 via RPI messages 210a.

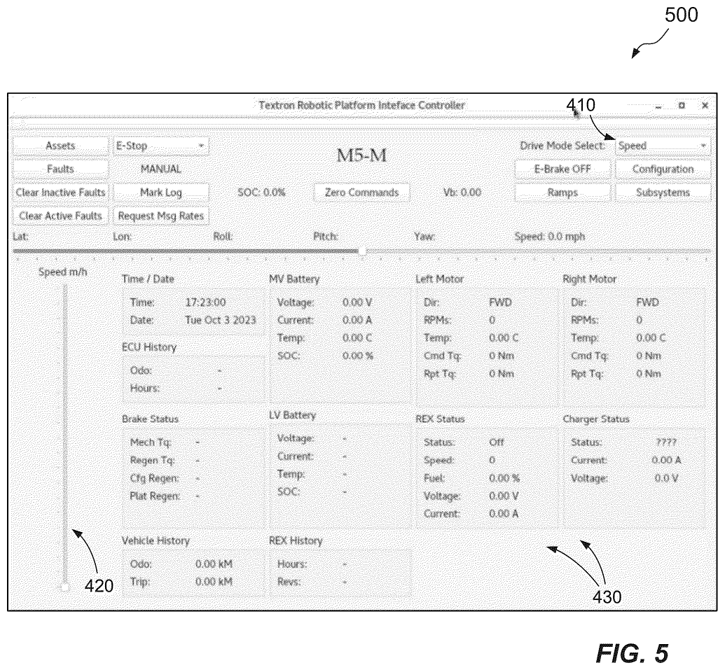

FIG. 5 shows an example screenshot 500 of the GUI 250, following a user selection of the speed control method from the drop-down list 410. Here, the method-specific region 420 has been changed to provide a visual representation of commanded speed. Although not shown in FIG. 5, the GUI may provide a button or other control to command a maximum speed. Speed can be trimmed up and down with a directional pad, and steering can be achieved using a joystick.

The speed method uses absolute values, rather than percentages, receiving user input of maximum speed in units of miles per hour or kilometers per hour, for example. The speed method may employ input from GPS and INS of the vehicle in regulating the vehicle speed. Alternatively or additionally, the speed method may employ an onboard vehicle speedometer. To slow down, the vehicle 120 may first use regeneration and later add service braking (wet brakes) to reach a specified speed.

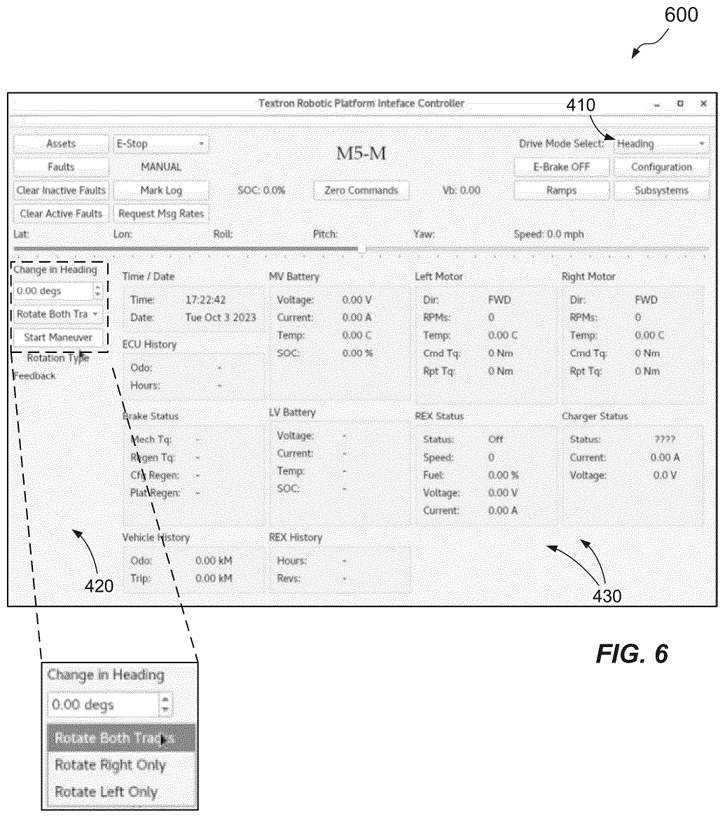

FIG. 6 shows an example screenshot 600 of the GUI 250, following a user selection of the heading control method from the drop-down list 410. Here, the method-specific region 420 has been changed to include a “Change in Heading” region, which allows the user to select a heading change (in degrees) and a rotation type. As shown in the enlarged view below, available rotation types include rotating both tracks, rotating the right track only, and rotating the left track only. The user can enter the desired heading change and rotation type and then click a “Start Maneuver” button or other control to initiate the heading change. Once pressed, the “Start Maneuver” button may change to a “Stop Maneuver” button, which the user may press to stop or interrupt the specified maneuver.

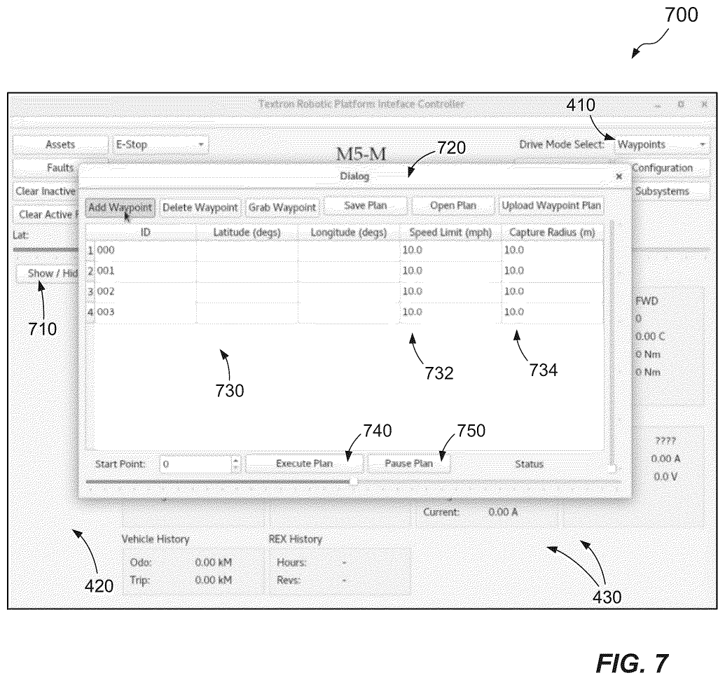

FIG. 7 shows an example screenshot 700 of the GUI 250, following a user selection of the waypoints control method from the drop-down list 410. Here, the method-specific region 420 has been changed to include a control 710, such as a button, for showing or hiding a waypoints dialog box 720, which is shown in the foreground of the figure. The dialog box 720 enables the user to enter any number of waypoints 730 by specifying their latitude and longitude. The user may also specify a speed limit 732 associated with travel to each waypoint and a capture radius 734, i.e., a distance away from the waypoint which, if reached by the vehicle, qualifies as having visited the waypoint. The user may click a button 740 to “Execute Plan,” which sends the list of waypoints to the vehicle 120 and initiates travel. The user may also click a button 750 to “Pause Plan,” which has the effect of pausing execution of the plan.

When the vehicle is controlled using the waypoints method or the heading method, any joystick input (or other directional input) from the handheld controller 102 may be interpreted as an instruction to stop asserting the waypoints or heading method and instead to begin asserting the speed control method. In an example, the GUI responds to any joystick input by changing the indicated control method to the speed method and switching the display to resemble what is shown in FIG. 5. The joystick input also causes the remote-control program 240 to send an RPI message 210a to the vehicle 120 to set the control method to the speed control method.

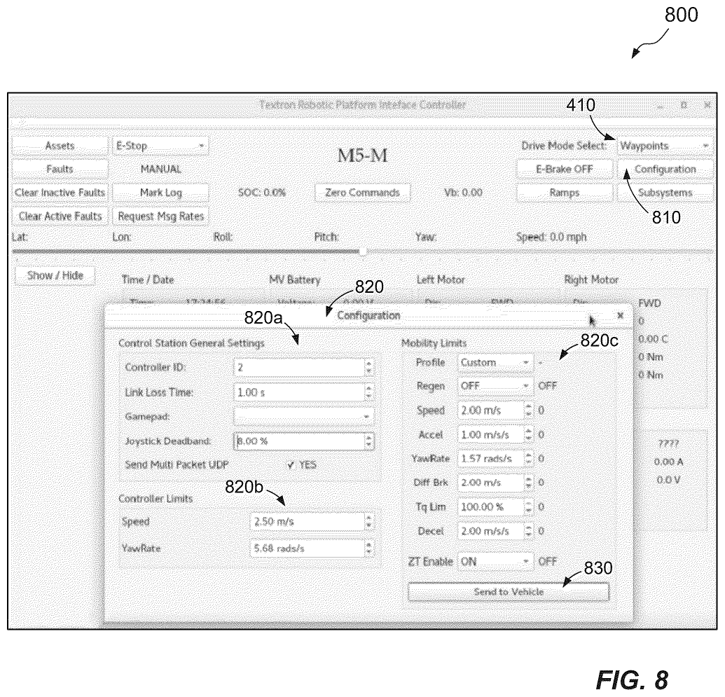

FIG. 8 shows an example screenshot 800 of the GUI 250, following a user activation of a configuration control 810, which may be provided as a button, for example. In response to the activation, the GUI 250 displays a configuration dialog box 820. As shown, the configuration dialog box 820 includes control station general settings 820a, which apply to the control computer 110 and handheld controller 102, controller limits 820b, which apply to control inputs, and mobility limits 820c, which apply to the vehicle 120. For example, control station general settings 820a include a setting for joystick deadband, which specifies a minimum joystick deflection required before the joystick input is interpreted as a control change. The controller limits 820b include speed and yaw rate, which limit maximum values that may be set by the controller. Mobility limits 820c are enforced by the vehicle 120 itself. The user may establish settings for regenerative braking, speed, acceleration, yaw rate, differential braking, torque limit, deceleration, and zero-turning, for example, and the control computer 110 may send established settings to the vehicle 120, e.g., in response to the user pressing a button 830. In the event that a controller limit 820b set by the user exceeds a mobility limit 820c for some parameter (e.g., yaw rate), the mobility setting 820c takes precedence. This arrangement ensures that the vehicle 120 is always in control of its own maximum settings.

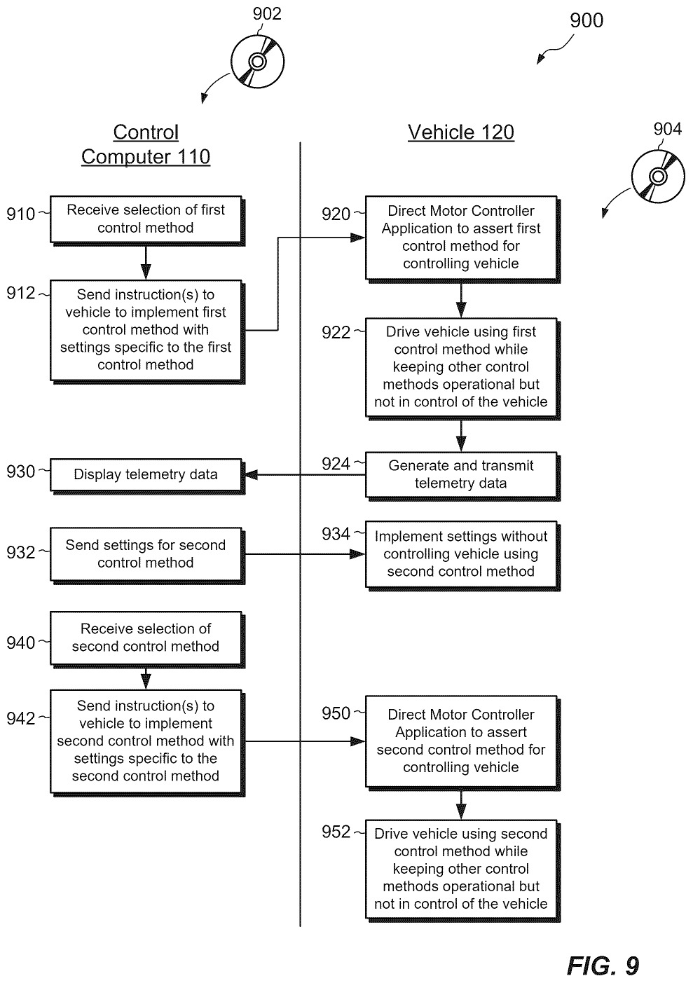

FIG. 9 shows an example method 900 for controlling a vehicle 120 using a control computer 110 and provides an overview of some of the features described above. Activities performed by the computer 110 are shown to the left, and activities performed by the vehicle 120 are shown to the right. One should appreciate that the depicted order of acts is merely illustrative, as embodiments may be constructed in which acts are performed in different orders, which may include performing some acts simultaneously.

At 910, the computer 110 receives, e.g., via the GUI 250, a selection of a first control method, which may be any of the above-described methods (e.g., torque, aided torque, speed, heading, or waypoint). At 912, the computer 110 sends one or more RPI messages 210a to the vehicle 210 to implement the first control method with settings specific to the first control method, such as torque settings, speed settings, heading settings, waypoint settings, or the like.

At 920, the vehicle receives the RPI message(s) and directs the motor controller application 330 to select the first control method as the selected method 332 for controlling the vehicle 120. At 922, the vehicle drives using the first control method while keeping the other control methods (or some subset of them) operational but not in control of the vehicle 120. At 924, as the vehicle operates, the vehicle 120 generates telemetry data and sends the telemetry data back to the computer 100. At 930, the computer 110 displays the telemetry data on the GUI 250. One should appreciate that acts 924 and 930 may be performed continuously.

At 932, the computer 110 sends one or more settings to the vehicle 120 defining operation of the vehicle under a second control method, which is not yet selected. At 934, the vehicle 120 implements the settings and operates the second control method without using the second control method to control the vehicle 120. Steps 932 and 934 may be optional in certain embodiments.

Sometime later, at 940, the computer 110 receives a user selection of a second control method, which is different from the first control method. At 942, the computer 110 sends one or more RPI messages 210a to the vehicle 210 to implement the second control method. The messages 210a may include settings specific to the second control method (e.g., if the settings were not sent previously).

At 950, the vehicle receives the RPI message(s) and directs the motor controller application 330 to select the second control method as the selected method 332 for controlling the vehicle 120. At 952, the vehicle drives using the second control method while keeping the other control methods (or some subset of them) operational but not in control of the vehicle 120.

An improved technique has been described for controlling a tracked robotic vehicle. The technique includes simultaneously operating multiple control methods within the vehicle based on established settings but selecting only a single control method for controlling the vehicle at a time. With the vehicle using a first control method, the vehicle receives a command for assuming a second control method and responds by selecting the second control method in place of the first control method for controlling the vehicle. Because the second control method is already operational with established settings when the command is received, the vehicle can transition instantly from the first control method to the second control method without having to stop the vehicle.

Having described certain embodiments, numerous alternative embodiments or variations can be made. Further, although features have been shown and described with reference to particular embodiments hereof, such features may be included and hereby are included in any of the disclosed embodiments and their variants. Thus, it is understood that features disclosed in connection with any embodiment are included in any other embodiment.

Further still, the improvement or portions thereof may be embodied as a computer program product including one or more non-transient, computer-readable storage media, such as a magnetic disk, magnetic tape, compact disk, DVD, optical disk, flash drive, solid state drive, SD (Secure Digital) chip or device, Application Specific Integrated Circuit (ASIC), Field Programmable Gate Array (FPGA), and/or the like. Any number of computer-readable media may be used, such as media 902 and 904 of FIG. 9.

The media may be encoded with instructions which, when executed on one or more computers or other processors, perform the process or processes described herein. Such media may be considered articles of manufacture or machines, and may be transportable from one machine to another.

As used throughout this document, the words “comprising,” “including,” “containing,” and “having” are intended to set forth certain items, steps, elements, or aspects of something in an open-ended fashion. Also, as used herein and unless a specific statement is made to the contrary, the word “set” means one or more of something. This is the case regardless of whether the phrase “set of” is followed by a singular or plural object and regardless of whether it is conjugated with a singular or plural verb. Also, a “set of” elements can describe fewer than all elements present. Thus, there may be additional elements of the same kind that are not part of the set. Further, ordinal expressions, such as “first,” “second,” “third,” and so on, may be used as adjectives herein for identification purposes. Unless specifically indicated, these ordinal expressions are not intended to imply any ordering or sequence. Thus, for example, a “second” event may take place before or after a “first event,” or even if no first event ever occurs. In addition, an identification herein of a particular element, feature, or act as being a “first” such element, feature, or act should not be construed as requiring that there must also be a “second” or other such element, feature or act. Rather, the “first” item may be the only one. Also, and unless specifically stated to the contrary, “based on” is intended to be nonexclusive. Thus, “based on” should be interpreted as meaning “based at least in part on” unless specifically indicated otherwise. Although certain embodiments are disclosed herein, it is understood that these are provided by way of example only and should not be construed as limiting.

Those skilled in the art will therefore understand that various changes in form and detail may be made to the embodiments disclosed herein without departing from the scope of the following claims.

What is claimed is:

1. A method of operating a vehicle, comprising:
controlling the vehicle using a first drive-control method in response to receiving a first set of messages from a control computer separate from the vehicle;
while controlling the vehicle using the first drive-control method, operating a second drive-control method that does not control the vehicle; and
in response to receiving a second set of messages from the control computer, switching from the first drive-control method to the second drive-control method such that the vehicle is controlled using the second drive-control method but not the first drive-control method.

2. The method of claim 1, wherein prior to switching from the first drive-control method to the second drive-control method, the method further comprises establishing one or more settings of the second drive-control method operating in the vehicle based on a third set of messages received from the control computer.

3. The method of claim 1, wherein switching from the first drive-control method to the second drive-control method is performed without stopping the vehicle.

4. The method of claim 1, wherein each of the first drive-control method and the second drive-control method is a respective one of:
a torque control method in which the vehicle produces respective torques by left and right motors of the vehicle based on input from the control computer,
a speed control method in which the vehicle runs at a desired speed based on input from the control computer;
a heading control method in which the vehicle drives in a desired heading based on input from the control computer, or
a waypoints control method in which the vehicle drives to a series of desired geographical locations based on input from the control computer.

5. The method of claim 4, wherein the first drive-control method is the speed control method and the second drive-control method is the waypoints control method.

6. The method of claim 4, wherein the first drive-control method is the torque control method and the second drive-control method is the speed control method.

7. The method of claim 6, wherein the torque control method is an aided torque control method, and wherein the method further comprises smoothing torque values received in the control commands from the control computer to prevent sudden changes in power applied to the left and right motors of the vehicle.

8. The method of claim 4, further comprising:
receiving messages from the control computer specifying settings of at least one of the speed control method, the heading control method, and the waypoints control method;
transforming the messages into torque control inputs for controlling the left and right motors; and
powering the left and right motors based on the torque control inputs.

9. The method of claim 1, further comprising, while operating the vehicle using one of the heading control method or the waypoints control method:
receiving directional input from the control computer indicating an instructed change in direction of the vehicle; and
automatically switching operation of the vehicle to the speed control method responsive to the directional input.

10. The method of claim 9, wherein the directional input is based on movement of a joystick of the control computer.

11. The method of claim 1, wherein operating the second drive-control method while controlling the vehicle using the first drive-control method includes running the second drive-control method open loop.

12. The method of claim 11, wherein operating the second drive-control method while controlling the vehicle using the first drive-control method further includes:
providing a set of inputs to the second drive-control method; and
generating a set of outputs of the second drive-control method based on the set of inputs.

13. The method of claim 12, wherein operating the second drive-control method while controlling the vehicle using the first drive-control method further includes limiting the set of outputs of the second drive-control method to levels expected under closed-loop control.

14. The method of claim 1, further comprising:
receiving a set of messages from the control computer specifying a set of mobility limits of the vehicle, the mobility limits include a speed limit of the vehicle; and
while operating the vehicle, limiting a maximum speed of the vehicle to the speed limit specified by the mobility limits.

15. The method of claim 1, wherein the set of mobility limits further include at least one of: maximum acceleration, maximum yaw rate, maximum differential braking rate, maximum torque, maximum deceleration, whether the vehicle is allowed to use regenerative braking, and whether the vehicle is allowed to perform zero turning, and wherein the method further comprises limiting the vehicle during operation to the set of mobility limits.

16. A tracked vehicle, comprising:
first and second tracks;
first and second motors respectively coupled to the first and second tracks;
a traction motor inverter coupled to the first and second motors; and
control circuitry constructed and arranged to:
control the vehicle using a first drive-control method in response to receipt of a first set of messages from a control computer separate from the vehicle;
while the vehicle is controlled using the first drive-control method, operate a second drive-control method that does not control the vehicle; and
in response to receipt of a second set of messages from the control computer, switch from the first drive-control method to the second drive-control method such that the vehicle is controlled using the second drive-control method but not the first drive-control method.

17. The tracked vehicle of claim 16, further comprising a wireless interface constructed and arranged to receive the first set of messages and the second set of messages from the control computer over a wireless connection.

18. The tracked vehicle of claim 17, wherein each of the first drive-control method and the second drive-control method is a respective one of:
a torque control method in which the vehicle is constructed and arranged to produce desired torques of left and right motors of the vehicle based on input from the control computer;
a speed control method in which the vehicle is constructed and arranged to run at a desired speed based on input from the control computer;
a heading control method in which the vehicle is constructed and arranged to drive in a desired heading based on input from the control computer; or
a waypoints control method in which the vehicle is constructed and arranged to drive to a series of geographical locations based on input from the control computer.

19. The tracked vehicle of claim 16, wherein the control circuitry constructed and arranged to operate the vehicle using one of the heading control method or the waypoints control method is further constructed and arranged to:
receive directional input from the control computer indicating an instructed change in direction of the vehicle; and
automatically switch operation of the vehicle to the speed control method responsive to the directional input.

20. The tracked vehicle of claim 16, wherein the control circuitry constructed and arranged to operate the second drive-control method while the vehicle is controlled using the first drive-control method is further constructed and arranged to run the second drive-control method open loop.
